(19) United States
(12) Patent Application Publication
(10) Pub. No.: US 2016/0324153 A1
(43) Pub. Date: Nov. 10, 2016

(54) HERBICIDAL MIXTURE COMPRISING IMAZETHAPYR AND CYCLOXYDIM

(71) Applicant: BASF AGROCHEMICAL PRODUCTS, Arnhem (NL)

(72) Inventors: Cyrill ZAGAR, Raleigh, NC (US); Edson BEGLIOMINI, Singapore (SG); Abhishek BEOHAR, Jabalpur (IN); Ajay CHANDOLA, Kotdwara (IN); Sudhakar KANDRU, Neustadt (DE); Yogesh OTURKAR, Mumbai (IN); Yogendra RATHORE, Indore (IN); Nilanjan SANYAL, Kolkata (IN); Satish GANIGER, Singapore (SG)

(21) Appl. No.: 15/109,362

(22) PCT Filed: Jan. 5, 2015
(86) PCT No.: PCT/EP2015/050061

§ 371 Date: Jun. 30, 2016

Related U.S. Application Data
(60) Provisional application No. 61/924,722, filed on Jan. 8, 2014.

(30) Foreign Application Priority Data
Feb. 11, 2014 (EP) 14154655.6

(51) Int. Cl. A01N 43/50; A01N 43/88; A01N 43/18

(52) U.S. Cl. CPC A01N 43/50; A01N 43/18; A01N 43/88

(57) ABSTRACT

The present invention relates to herbicidally active compositions, which comprise 5-ethyl-2-[(RS)-4-isopropyl-4-methyl-5-oxo-2-imidazolin-2-yl]nicotinic acid (common name: imazethapyr) and (5RS)-2-[(EZ)-1-(Ethoxyimino)butyl]-3-hydroxy-5-[(3RS)-thian-3-yl]cyclohex-2-en-1-one (common name: cycloxydim) and optionally 2-[(RS)-4-isopropyl-4-methyl-5-oxo-2-imidazolin-2-yl]-5-methoxymethylnicotinic acid (common name: imazamox).

### FIELD OF THE INVENTION

The present invention relates to herbicidally active compositions, which comprise 5-ethyl-2-[(RS)-4-isopropyl-4-methyl-5-oxo-2-imidazolin-2-yl]nicotinic acid (common name: imazethapyr) and (5RS)-2-[(EZ)-1-(Ethoxyimino)butyl]-3-hydroxy-5-[(3RS)-thian-3-yl]cyclohex-2-en-1-one (common name: cycloxydim) and optionally 2-[(RS)-4-isopropyl-4-methyl-5-oxo-2-imidazolin-2-yl]-5-methoxymethylnicotinic acid (common name: imazamox).

Further, the invention relates to herbicidally active compositions comprising imazethapyr, cycloxydim and bentazone and optionally imazamox.

### BACKGROUND OF THE INVENTION

In crop protection, it is desirable in principle to increase the specificity and the reliability of the action of active compounds. In particular, it is desirable for the crop protection product to control the harmful plants effectively and, at the same time, to be tolerated by the useful plants in question.

5-ethyl-2-[(RS)-4-isopropyl-4-methyl-5-oxo-2-imidazolin-2-yl]nicotinic acid (common name: imazethapyr; formula I) is an active compound from the group of imidazolinone herbicides, which are known e.g. from Shaner, D. L., O'Conner, S. L, The Imidazolinone Herbicides, CRC Press Inc., Boca Raton, Fla. 1991 and also from The Compendium of Pesticide Common Names http://www.alanwood.net/pesticides/.

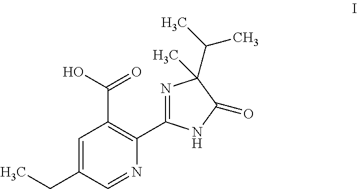 [SMILES: CCc1cnc(C2=NC(C)(C(C)C)C(=O)N2)c(C(=O)O)c1]

(5RS)-2-[(EZ)-1-(Ethoxyimino)butyl]-3-hydroxy-5-[(3RS)-thian-3-yl]cyclohex-2-en-1-one (common name: cycloxydim; formula II) is an active compound from the group of cyclohexanedione herbicides.

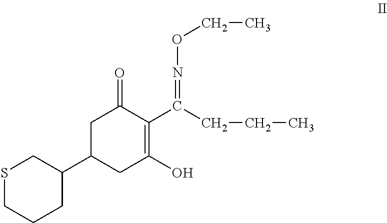 [SMILES: CCCC(=NOCC)C1=C(O)CC(C2CCCSC2)CC1=O]

2-[(RS)-4-isopropyl-4-methyl-5-oxo-2-imidazolin-2-yl]-5-methoxymethylnicotinic acid (common name: imazamox; formula III) is an active compound from the group of imidazolinone herbicides, which are known e.g. from Shaner, D. L. O'Conner, S. L The Imidazolinone Herbicides, CRC Press Inc., Boca Raton, Fla. 1991 and also from The Compendium of Pesticide Common Names http://www.alanwood.net/pesticides/.

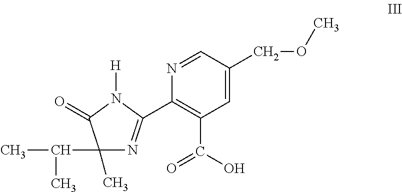 [SMILES: COCc1cnc(C2=NC(C)(C(C)C)C(=O)N2)c(C(=O)O)c1]

3-isopropyl-1H-2,1,3-benzothiadiazin-4(3H)-one 2,2-dioxide (common name: bentazone; formula IV) is an active compound from the group of thiadiazine herbicides.

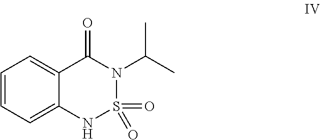 [SMILES: CC(C)N1C(=O)c2ccccc2NS1(=O)=O]

Although both imazethapyr and combinations of imazethapyr with imazamox (for example commercialized under the Odyssey® brand) are highly effective pre- and post-emergence herbicides, in some cases they do not provide a sufficient control of the relevant harmful plants and their activity at low application rates is not always satisfactory. Apart from that, its compatibility with certain dicotyledonous crop plants such as soybean, peanuts or other pulse or leguminous crops is not always satisfactory, i.e. in addition to the harmful plants, the crop plants are also damaged to an extent which is not acceptable. Though it is in principle possible to spare crop plants by lowering the application rates, the extent of the control of harmful plants is naturally also reduced.

### DETAILED DESCRIPTION OF THE INVENTION

It is an object of the present invention to provide herbicidal compositions, which show enhanced herbicide action against undesirable harmful plants, in particular against Acalypha species such as Acalypha indica, Dinebra species such as Dinebra Arabica, Cynotis spec such as Cynotis axillaris, Parthenium spec such as Parthenium hysterophorus, Physalis spec such as Physalis minima, Digera spec such as Digera arvensis, Alopecurus myosuroides, Apera spicaventi, Brachiaria spec. such as Brachiaria deflexa or Brachiaria plantaginea, Echinochloa spec. such as Echinochloa colonum, Leptochloa spec. such as Leptochloa fusca, Rottboellia cochinchinensis, Digitaria sanguinalis, Eleusine indica, Saccharum spontaneum, Cynodon dactylon, Euphorbia hirta, Euphorbia geniculata, Commelina benghalensis, Commelina communis, certain undesired Oryza spec. such as weedy rice or red rice (Oryza sativa), Phalaris spec. such as Phalaris canariensis, Celosia argentea, Xanthium strumarium, Papaver rhoeas, Geranium spec, Brassica spec, Avena fatua, Bromus spec., Lolium spec., Phalan spec., Setaria spec., Digitaria spec., brachiaria spec., Amaranthus spec., Chenopodium spec., Abutilon theophrasti, Galium aparine, Veronica spec., or Solanum spec. and/or to improve their compatibility with crop plants, such as soybean, peanut, pea, bean, lentil, green gram, black gram, cluster bean, fenugreek, other pulse or leguminous crops, or crops which are tolerant to the action of acetohydroxyacid synthase inhibiting herbicides, such as for example Clearfield® wheat, Clearfield® barley, Clearfield® corn, Clearfield® lentil, Clearfield® oilseed rape or canola, Clearfield® rice, Cultivance® soybean and/or Clearfield® sunflower. The composition should also have a good pre-emergence herbicidal activity.

We consider this object to be achievable, by herbicidally active compositions comprising imazethapyr or agriculturally acceptable salts thereof and cycloxydim or agriculturally acceptable salts thereof and optionally imazamox or agriculturally acceptable salts thereof.

Further, we consider this object to be achievable, by herbicidally active compositions comprising imazethapyr or agriculturally acceptable salts thereof, cycloxydim or agriculturally acceptable salts thereof and bentazone or agriculturally acceptable salts thereof and optionally imazamox or agriculturally acceptable salts thereof.

The invention relates in particular to compositions in the form of agriculturally acceptable compositions as defined above.

The invention furthermore relates to the use of compositions as defined herein for controlling undesirable vegetation in crops. When using the compositions of the invention for this purpose the imazethapyr agriculturally acceptable salts thereof and cycloxydim agriculturally acceptable salts thereof and optionally imazamox or agriculturally acceptable salts thereof can be applied simultaneously or in succession in crops, where undesirable vegetation may occur.

When using the compositions of the invention for this purpose the imazamox or agriculturally acceptable salts thereof and cycloxydim or agriculturally acceptable salts thereof can be applied simultaneously or in succession in crops, where undesirable vegetation may occur.

The invention furthermore relates to the use of compositions as defined herein for controlling undesirable vegetation in crops which, by genetic engineering or by breeding, are tolerant to one or more herbicides, e.g. acetohydroxyacid synthase inhibiting herbicides such as imazethapyr or imazamox, and/or pathogens such as plant-pathogenous fungi, and/or to attack by insects; preferably tolerant to one or more herbicides that act as acetohydroxyacid synthase inhibitors.

The invention furthermore relates to a method for controlling undesirable vegetation, which comprises applying an herbicidal composition according to the present invention to the undesirable plants. Application can be done before, during and/or after, preferably during and/or after, the emergence of the undesirable plants.

The combination of imazethapyr or agriculturally acceptable salts thereof and cycloxydim or agriculturally acceptable salts thereof and optionally imazamox or agriculturally acceptable salts thereof can be applied simultaneously or in succession. The combination of imazethapyr or agriculturally acceptable salts thereof, cycloxydim or agriculturally acceptable salts thereof and bentazone or agriculturally acceptable salts thereof and optionally imazamox or agriculturally acceptable salts thereof can be applied simultaneously or in succession.

The invention in particular relates to a method for controlling undesirable vegetation in crops, which comprises applying an herbicidal composition according to the present invention in crops where undesirable vegetation occurs or might occur.

The invention furthermore relates to a method for controlling undesirable vegetation, which comprises allowing a composition according to the present invention to act on plants, their habitat or on seed.

In the methods of the present invention it is immaterial whether the combination of imazethapyr or agriculturally acceptable salts thereof and cycloxydim or agriculturally acceptable salts thereof and optionally imazamox or agriculturally acceptable salts thereof or the combination imazethapyr or agriculturally acceptable salts thereof, cycloxydim or agriculturally acceptable salts thereof and bentazone or agriculturally acceptable salts thereof and optionally imazamox or agriculturally acceptable salts thereof are formulated and applied jointly or separately, and, in the case of separate application, in which order the application takes place. It is only necessary, that the combination of imazethapyr or agriculturally acceptable salts thereof and cycloxydim or agriculturally acceptable salts thereof and optionally imazamox or agriculturally acceptable salts thereof or the combination of imazethapyr or agriculturally acceptable salts thereof, cycloxydim or agriculturally acceptable salts thereof, bentazone or agriculturally acceptable salts thereof and optionally imazamox or agriculturally acceptable salts thereof are applied in a time frame, which allows simultaneous action of the active ingredients on the plants.

The invention also relates to an herbicide formulation, which comprises an agriculturally acceptable composition as defined herein and at least one carrier material, including liquid and/or solid carrier materials.

It is believed that the compositions according to the invention have better herbicidal activity against harmful plants than would have been expected by the herbicidal activity of the individual compounds. In other words, the joint action of the imazethapyr and cycloxydim combination, the imazethapyr, cycloxydim and imazamox combination, the imazethapyr, cycloxydim and bentazone combination and the imazethapyr, cycloxydim, bentazone and imazamox combination result in an enhanced activity against harmful plants in the sense of a synergy effect (synergism). For this reason, the compositions can, based on the individual components, be used at lower application rates to achieve a herbicidal effect comparable to the individual components. The compositions of the invention also show an accelerated action on harmful plants, i.e. damaging of the harmful plants is achieved more quickly in comparison with application of the individual herbicides. Moreover, the compositions of the present invention provide good pre-emergence herbicidal activity, i.e. the compositions are particularly useful for combating/controlling harmful plants before their emergence. Apart from that, the compositions of the present invention show good crop compatibility, i.e. their use in crops leads to a reduced damage of the crop plants.

As used herein, the terms “controlling” and “combating” are synonyms.

As used herein, the terms “undesirable vegetation” and “harmful plants” are synonyms.

Where reference is made to imazethapyr, this includes the free acid as well as agriculturally acceptable salts thereof.

Examples of agriculturally acceptable salts of imazethapyr include alkaline or earth alkaline metals or ammonium or organoammonium salts, for instance, sodium, potassium, ammonium and isopropyl ammonium. Particularly preferred is imazethapyr ammonium salt. Reference to a salt includes the anhydrous form as well as hydrated forms thereof.

Where reference is made to cycloxydim, this includes the free acid as well as agriculturally acceptable salts thereof.

Examples of agriculturally acceptable salts of cycloxydim include alkaline or earth alkaline metals or ammonium or organoammonium salts, for instance, lithium, sodium, potassium, ammonium and isopropyl ammonium. Particularly preferred are the lithium and the sodium salt of cycloxydim. Reference to a salt includes the anhydrous form as well as hydrated forms thereof.

Where reference is made to imazamox, this includes the free acid as well as agriculturally acceptable salts thereof.

Examples of agriculturally acceptable salts of imazamox include alkaline or earth alkaline metals or ammonium or organoammonium salts, for instance, sodium, potassium, ammonium and isopropyl ammonium. Particularly preferred is imazamox ammonium salt. Reference to a salt includes the anhydrous form as well as hydrated forms thereof.

Where reference is made to bentazone, this includes the free base as well as agriculturally acceptable salts thereof.

Examples of agriculturally acceptable salts of bentazone include alkaline or earth alkaline metals or ammonium or organoammonium salts, for instance, lithium, sodium, potassium, magnesium, calcium, ammonium, methylammonium, dimethylammonium, methyltrioctylammonium and isopropyl ammonium as well as the diethanolamine and choline salts. Particularly preferred is bentazone sodium salt. Reference to a salt includes the anhydrous form as well as hydrated forms thereof.

The compositions of the invention comprise the herbicidally active agents imazethapyr and cycloxydim and optionally imazamox.

Imazethapyr may be present in the form of its racemate or in the form of the pure R- or S-enantiomers (including salts as defined above). In particular suitable is R-imazethapyr. Cycloxydim may be present in the form of its racemate or in the form of the pure R- or S-enantiomers, or it may be present in the form of pure stereoisomers with respect to the two chiral centers and the ethoxyimino group, or as mixtures of two or more such stereoisomers (in each case, including salts as defined above). Particularly preferred is a racemic mixture of stereoisomers. Imazamox may be present in the form of its racemate or in the form of the pure R- or S-enantiomers (including salts as defined above). In particular suitable is R-imazamox.

The compositions of the invention may also comprise one or more safeners. Safeners, also termed as herbicide safeners, are organic compounds which in some cases lead to better crop plant compatibility when applied jointly with specifically acting herbicides. Some safeners are themselves herbicidally active. In these cases, the safeners act as antidote or antagonist in the crop plants and thus reduce or even prevent damage to the crop plants. However, in the compositions of the present invention, safeners are generally not required. Therefore, a preferred embodiment of the invention relates to compositions which contain no safener or virtually no safener (i.e. less than 1% by weight, based on the total amount of imazethapyr and cycloxydim and optionally imazamox).

Suitable safeners, which can be used in the compositions according to the present invention are known in the art, e.g. from The Compendium of Pesticide Common Names (http://www.alanwood.net/pesticides/); Farm Chemicals Handbook 2000 Vol. 86, Meister Publishing Company, 2000; B. Hock, C. Fedtke, R. R. Schmidt, Herbizide, Georg Thieme Verlag, Stuttgart 1995; W. H. Ahrens, Herbicide Handbook, 7th Edition, Weed Science Society of America, 1994; and K. K. Hatzios, Herbicide Handbook, Supplement to 7th Edition, Weed Science Society of America, 1998.

Safeners include benoxacor, cloquintocet, cyometrinil, cyprosulfamide, dichlormid, dicyclonon, dietholate, fenchlorazole, fenclorim, flurazole, fluxofenim, furilazole, isoxadifen, mefenpyr, mephenate, naphthalic anhydride, 2,2,5-trimethyl-3-(dichloracetyl)-1,3-oxazolidine, 4-(dichloroacetyl)-1-oxa-4-azaspiro[4.5]decane and oxabetrinil, as well as thereof agriculturally acceptable salts and, provided they have a carboxyl group, their agriculturally acceptable derivatives. 2,2,5-Trimethyl-3-(dichloroacetyl)-1,3-oxazolidine [CAS No. 52836-31-4] is also known under the name R-29148.4-(Dichloroacetyl)-1-oxa-4-azaspiro[4.5]decane [CAS No. 71526-07-03] is also known under the names AD-67 and MON 4660.

As safener, the compositions according to the invention particularly preferably com-prise at least one of the compounds selected from the group of benoxacor, cloquintocet, cyprosulfamide, dichlormid, fenchlorazole, fenclorim, fluxofenim, furilazole, isoxadifen, mefenpyr, naphthalic anhydride, 2,2,5-trimethyl-3-(dichloroacetyl)-1,3-oxazolidine, and 4-(dichloroacetyl)-1-oxa-4-azaspiro[4.5]decane and oxabetrinil; and the agriculturally acceptable salt thereof and, in the case of compounds having a COOH group, an agriculturally acceptable derivative as defined below.

A preferred embodiment of the invention relates to compositions which contain no safener or virtually no safener (i.e. less than 1% by weight, based on the total amount of imazethapyr and cycloxydim and optionally imazamox) is applied.

If the compounds of herbicidally active compounds mentioned as safeners (see above) have functional groups, which can be ionized, they can also be used in the form of their agriculturally acceptable salts. In general, the salts of those cations are suitable whose cations have no adverse effect on the action of the active compounds (“agricultural acceptable”).

In general, the salts of those cations are suitable whose cations have no adverse effect on the action of the active compounds (“agriculturally acceptable”). Preferred cations are the ions of the alkali metals, preferably of lithium, sodium and potassium, of the alkaline earth metals, preferably of calcium and magnesium, and of the transition metals, preferably of manganese, copper, zinc and iron, furthermore ammonium and substituted ammonium (hereinafter also termed as organoammonium) in which one to four hydrogen atoms are replaced by C1-C4-alkyl, hydroxy-C1-C4-alkyl, C1-C4-alkoxy-C1-C4-alkyl, hydroxy-C1-C4-alkoxy-C1-C4-alkyl, phenyl or benzyl, preferably ammonium, methylammonium, isopropylammonium, dimethylammonium, diisopropylammonium, trimethylammonium, tetramethylammonium, tetraethylammonium, tetrabutylammonium, 2-hydroxyethylammonium, 2-(2-hydroxyethoxy)eth-1-ylammonium, di(2-hydroxyeth-1-yl)ammonium, benzyltrimethylammonium, benzyltriethylammonium, furthermore phosphonium ions, sulfonium ions, preferably tri(C₁-C₄-alkyl)sulfonium such as trimethylsulfonium, and sulfoxonium ions, preferably tri(C₁-C₄-alkyl)sulfoxonium.

In the compositions according to the invention, the compounds that carry a carboxyl group can also be employed in the form of agriculturally acceptable derivatives, for example as amides such as mono- or di-C₁-C₆-alkylamides or arylamides, as esters, for example as allyl esters, propargyl esters, C₁-C₁₀-alkyl esters or alkoxyalkyl esters, and also as thioesters, for example as C₁-C₁₀-alkyl thioesters. Preferred mono- and di-C₁-C₆-alkylamides are the methyl- and the dimethylamides. Preferred arylamides are, for example, the anilidines and the 2-chloroanilides. Preferred alkyl esters are, for example, the methyl, ethyl, propyl, isopropyl, butyl, isobutyl, pentyl, mexyl (1-methylhexyl) or isooctyl (2-ethylhexyl) esters. Preferred C₁-C₄-alkoxy-C₁-C₄-alkyl esters are the straight-chain or branched C₁-C₄-alkoxyethyl esters, for example the methoxyethyl, ethoxyethyl or butoxyethyl esters. An example of the straight-chain or branched C₁-C₁₀-alkyl thioesters is the ethyl thioester. Preferred derivatives are the esters.

The compositions of the present invention are suitable for controlling a large number of harmful plants, including monocotyledonous weeds, in particular annual weeds such as gramineous weeds (grasses) including Echinochloa species such as barnyardgrass (Echinochloa crusgalli var crus-galli) or Echinochloa colonum, Digitaria species such as crabgrass (Digitaria sanguinalis), certain undesired Oryza spec. such as weedy rice or red rice (Oryza sativa), Setaria species such as green foxtail (Setaria viridis) and giant foxtail (Setaria faberil), Sorghum species such as johnsongrass (Sorghum halepense Pers.), Avena species such as wild oats (Avena fatua), Cenchrus species such as Cenchrus echinatus, Bromus species, Lolium species, Leptochloa spec. such as Leptochloa fusca, Phalaris species such as Phalaris canariensis, Eriochloa species, Panicum species, Brachiaria species such as Brachiaria deflexa or Brachiaria plantaginea, annual bluegrass (Poa annua), blackgrass (Alopecurus myosuroides), Aegilops cylindrica, Agropyron repens, Apera spica-venti, Eleusine indica, Cynodon dactylon, Rottboellia cochinchinensis, Dinebra species such as Dinebra arabica, Saccharum spontaneum, and the like.

The invention is particular suitable for controlling monocotyledonous weeds selected from the group consisting of Echinochloa spec. such as Echinochloa colonum, Leptochloa spec. such as Leptochloa fusca, certain undesired Oryza spec. such as weedy rice or red rice (Oryza sativa), Phalaris spec. such as Phalaris canariensis, Brachiaria spec. such as Briachiaria deflexa or Brachiaria plataginea.

The compositions of the present invention are also suitable for controlling a large number of dicotyledonous weeds, in particular broad leaf weeds including Acalypha species such as Acalypha indica, Polygonum species such as wild buckwheat (Polygonum convolvolus), Amaranthus species such as pigweed (Amaranthus retroflexus) or Amaranthus viridis, Chenopodium species such as common lambsquarters (Chenopodium album L.), Sida species such as prickly sida (Sida spinosa L.), Ambrosia species such as common ragweed (Ambrosia artemisiifolia), Acanthospermum species, Anthemis species, Atriplex species, Cirsium species, Convolvulus species, Conyza species, Cassia species, Commelina species such as for example Commelina communis or Commelina benghalens, Datura species, Euphorbia species such as for example Euphorbia hirta or Euphorbia geniculata, Geranium species, Galinsoga species, morningglory (Ipomoea species), Lamium species, Malva species, Matricaria species, Sysimbrium species, Solanum species, Xanthium species such as for example Xanthium strumiarium, Veronica species, Viola species, common chickweed (Stellaria media), velvetleaf (Abutilon theophrast), Hemp sesbania (Sesbania exaltata Cory), Anoda cristata, Bidens pilosa, Brassica kaber, Capsella bursa-pastoris, Centaurea cyanus, Galeopsis tetrahit, Galium aparine, Helianthus annuus, Desmodium tortuosum, Kochia scoparia, Mercurialis annua, Myosotis arvensis, Papaver rhoeas, Raphanus raphanistrum, Salsola kali, Sinapis arvensis, Sonchus arvensis, Thlaspi arvense, Tagetes minuta, Richardia braslliensis, Rumex crispus, Rumex obtusifolius, Heracleaum sphondylium, Aethusa cynapium, Daucus carota, Equisetum arvense, Celosia argentea, Cynotis species such as Cynotis axilaris, Parthenium species such as Parthenium hysterophorus, Physalis species such as Physalis minima, Digera species such as Digera arvensis, and the like.

The herbicidal composition comprising imazethapyr and cycloxydim is particular suitable for controlling monocotyledonous weeds, preferably Echinochloa spec., Leptochloa spec., Orysa spec., Phalaris spec., Brachiaria spec., more preferably Echinochloa spec. such as Echinochloa colonum, Leptochloa spec. such as Leptochloa fusca and Orysa spec. such as Orysa sativa.

The herbicidal comprising imazethapyr, imazamox and cycloxydim is particular suitable for Echinochloa spec., Leptochloa spec., Orysa spec., Phalaris spec., Brachiaria spec., more preferably Phalaris spec. such as Phalaris canariensis, Echinochloa spec. such as Echinochloa colonum, Phalaris spec. such as Phalaris canariensis, Orysa spec. such as Orysa sativa and Brachiaria spec. such as Brachiaria plantaginea.

The combination of imazethapyr and cycloxydim is in particular useful against annual and perennial grasses and broad-leaved weeds in post-emergence application.

The compositions of the present invention are also suitable for controlling a large number of annual and perennial sedge weeds including cyperus species such as purple nutsedge (Cyperus rotundus L.), yellow nutsedge (Cyperus esculentus L.), hime-kugu (Cyperus brevifolius H.), sedge weed (Cyperus microiria Steud), rice flatsedge (Cyperus iria L.), and the like.

The compositions according to the present invention are suitable for combat-ing/controlling common harmful plants in useful plants (i.e. in crops). The compositions of the present invention are generally suitable for combating/controlling undesired vegetation in
Legumes (Fabaceae), including e.g. soybeans (Glycine max), peanuts (Arachis hypogaea) and pulse crops such as peas including Pisum sativum, pigeon pea and cowpea, beans including broad beans (Vicia faba), Vigna spp., and Phaseolus spp. and lentils (lens culinaris var.).
   crops which are tolerant to the action of acetohydroxyacid synthase inhibiting herbicides, such as for example Clearfield® wheat, Clearfield® barley, Clearfield® corn, Clearfield® lentil, Clearfield® oilseed rape or canola, Clearfield® rice, Cultivance® soybean and/or Clearfield® sunflower.

The compositions of the present invention are in particular suitable for combat-ing/controlling undesired vegetation in soybean, peanut, pea, bean, lentil, green gram, black gram, cluster bean, fenugreek, other pulse or leguminous crops, or crops which are tolerant to the action of acetohydroxyacid synthase inhibiting herbicides, such as for example Clearfield® wheat, Clearfield® barley, Clearfield® corn, Clearfield® lentil, Clearfield® oilseed rape or canola, Clearfield® rice, Cultivance® soybean and/or Clearfield® sunflower.

The compositions of the present invention are most suitable for combating/controlling undesired vegetation in soybean, peanut, pea, bean, lentil, green gram, black gram, cluster bean, fenugreek, other pulse or leguminous crops, preferably soybean (Glycine max).

If not stated otherwise, the compositions of the invention are suitable for application in any variety of the aforementioned crop plants.

The compositions according to the invention can also be used in crop plants which are tolerant to one or more herbicides owing to genetic engineering or breeding, which are resistant to one or more pathogens such as plant pathogenous fungi to genetic engineering or breeding, or which are resistant to attack by insects owing to genetic engineering or breeding. Suitable are for example pulse or leguminous crop plants, preferably soybean, peanut, pea, bean, green gram, black gram, cluster bean, fenugreek, or lentil which are tolerant to herbicidal AHAS inhibitors, such as, for example imazethapyr, or pulse or leguminous crop plants, preferably soybean, peanut, pea, bean, green gram, black gram, cluster bean, fenugreek, or lentil which, owing to introduction of the gene for Bt toxin by genetic modification, are resistant to attack by certain insects. Most suitable are soybeans which are tolerant to herbicidal AHAS inhibitors, such as, for example imazethapyr or soybean plants which, owing to introduction of the gene for Bt toxin by genetic modification, are resistant to attack by certain insects.

The compositions of the present invention can be applied in conventional manner by using techniques as skilled person is familiar with. Suitable techniques include spraying, atomizing, dusting, spreading or watering. The type of application depends on the intended purpose in a well known manner; in any case, they should ensure the finest possible distribution of the active ingredients according to the invention.

The compositions can be applied pre- or post-emergence, i.e. before, during and/or after emergence of the undesirable plants. Preferably, the compositions are applied post-emergence, in particular after the emergence of both the crop and the undesirable plants. When the compositions are used in crops, they can be applied after seeding and before or after the emergence of the crop plants. The compositions invention can, however, also be applied prior to seeding of the crop plants.

In any case imazethapyr and cycloxydim and optionally imazamox can be applied simultaneously or in succession.

Also imazethapyr, cycloxydim, bentazone and optionally imazamox can be applied simultaneously or in succession.

The compositions are applied to the plants mainly by spraying, in particular foliar spraying. Application can be carried out by customary spraying techniques using, for example, water as carrier and spray liquor rates of from about 10 to 2000 l/ha or 50 to 1000 l/ha (for example from 100 to 500 l/ha). Application of the herbicidal compositions by the low-volume and the ultra-low-volume method is possible, as is their application in the form of microgranules.

In the case of a post-emergence treatment of the plants, the herbicidal mixtures or compositions according to the invention are preferably applied by foliar application. Application may be effected, for example, by usual spraying techniques with water as the carrier, using amounts of spray mixture of approx. 20 to 1000 l/ha.

The required application rate of the composition of the pure active compounds, i.e. of imazethapyr, cycloxydim and optionally imazamox and/or safener (imazethapyr, cycloxydim and bentazone and optionally imazamox and/or safener respectively) depends on the density of the undesired vegetation, on the development stage of the plants, on the climatic conditions of the location where the composition is used and on the application method. In general, the application rate of the composition (total amount of imazethapyr, cycloxydim and optional further actives) is from 1 to 2,000 g/ha, preferably from 5 to 500 g/ha of active substance.

The required application rates of imazethapyr are generally in the range from 1 g/ha to 200 g/ha and preferably in the range from 5 g/ha to 150 g/ha or from 10 g/ha to 100 g/ha of active substance.

The required application rates of cycloxydim are generally in the range from 1 g/ha to 200 g/ha and preferably in the range from 2 g/ha to 150 g/ha or from 5 g/ha to 100 g/ha of active substance.

The required application rates of imazamox are generally in the range from 1 g/ha to 100 g/ha and preferably in the range from 5 g/ha to 75 g/ha or from 10 g/ha to 50 g/ha of active substance.

The imazethapyr/cycloxydim combination is usually in a weight ratio range of 100:1 to 1:100, preferably of 10:1 to 1:10, or 1:3 to 3:1, more preferably 1:2 to 2:1.

In those combinations which contain imazamox in addition to imazethapyr and cycloxydim, the weight ratio of imazethapyr to imazamox is usually in the range of 10:1 to 1:10, preferably of 5:1 to 1:5, more preferably 2:1 to 1:2.

In those combinations which contain imazamox in addition to imazethapyr and cycloxydim, the weight ratio of the total amount of imazethapyr and imazamox to cycloxydim is 1:20 to 20:1 or 1:10 to 10:1, more preferably 1:2 to 2:1.

In those combinations which contain imazethapyr, cycloxydim and bentazone, the weight ration of imazethapyr to bentazone is from ranges from 1:500 to 10:1 or 1:100 to 1:1 or 1:20 to 1:3

In those combinations which contain imazethapyr, cycloxydim and bentazone, the weight ration of cycloxydim to bentazone is from ranges from 1:500 to 10:1 or 1:100 to 1:1 or 1:20 to 1:3.

In those combinations which contain imazethapyr, cycloxydim, bentazone and imazamox, the weight ratio of the total amount of imazethapyr and imazamox to bentazone is 10:1 to 1:500 or 1:1 to 1:100 or 1:3 to 1:20.

The required application rates of the safener, if applied, are generally in the range from 1 g/ha to 2,000 g/ha and preferably in the range from 2 g/ha to 2,000 g/ha or from 5 g/ha to 2,000 g/ha of active substance. Preferably no safener or virtually no safener is applied.

The compositions of these embodiments are particularly suitable for controlling mono- and dicotyledonous weeds and sedge weeds, in particular Acalypha spec., Physalis spec., Digera spec., Aegilops Cylindrica, Agropyron repens, Alopecurus myosuroides, Avena fatua, Brassica spec., Brachiaria spec., Bromus spec., Echinochloa spec. such as for example Echinochloa colonum, Lolium spec., Phalaris spec., red rice, Setaria spec., Leptochloa spec. such as Leptochloa fusca, Orysa spec. such as Orysa sativa, Sorghum spec., Abuthilon theoprasti, Amarantus spec., Brassica kaber, Capsella bursa-pastoris, Chenopodium spec., Cyperus spec., Euphorbia spec. such as for example Euphorbia hirta or Euphorbia geniculata, Geranium sepc., Ipomoea spec., Polygonum spec., Raphanus raphanistrum, Sinapis arevensis, Sysimbrium spec., Thlaspi arvense, Rottboellia cochinchinensis, Dinebra spec., Digitaria sanguinalis, Eleusine indica, Saccharum spontaneum, Cynodon dactylon, Commelina benghalensis, Commelina communis, Parthenium spec., Celosia argentea, Cynotis spp and Xanthium strumarium.

The compositions of these embodiments are particularly suitable for controlling monocotyledonous weeds, preferably Echinochloa spec., Leptochloa spec., Orysa spec., Phalaris spec., Brachiaria spec.

The compositions of these embodiments are in particular suitable for combating undesired vegetation in soybean, peanut, pea, bean, lentil, green gram, black gram, cluster bean, fenugreek, other pulse or leguminous crops, or crops which are tolerant to the action of acetohydroxyacid synthase inhibiting herbicides, such as for example Clearfield® wheat, Clearfield® barley, Clearfield® corn, Clearfield® lentil, Clearfield® oilseed rape or canola, Clearfield® rice, Cultivance® soybean and/or Clearfield® sunflower. The compositions of these embodiments are most suitable for combating undesired vegetation in soybean, peanut, pea, bean, lentil, green gram, black gram, cluster bean, fenugreek, other pulse or leguminous crops, preferably soybean.

If not stated otherwise, the compositions of this embodiment are suitable for application in any variety of the aforementioned crop plants.

In particular, the compositions of these embodiments are suitable for application in soybean, peanut, pea, bean, lentil, green gram, black gram, cluster bean, fenugreek, other pulse or leguminous crops, preferably soybean.

The present invention also relates to formulations of the compositions according to the present invention. The formulations contain, besides the composition, at least one organic or inorganic carrier material. The formulations may also contain, if desired, one or more surfactants and, if desired, one or more further auxiliaries customary for crop protection compositions.

The formulation may be in the form of a single package formulation containing both imazethapyr and cycloxydim and optionally imazamox together with liquid and/or solid carrier materials, and, if desired, one or more surfactants and, if desired, one or more further auxiliaries customary for crop protection compositions. The formulation may be in the form of a two package formulation, wherein one package contains a formulation of imazethapyr and optionally imazamox while the other package contains a formulation of cycloxydim and wherein both formulations contain at least one carrier material, if desired, one or more surfactants and, if desired, one or more further auxiliaries customary for crop protection compositions. In the case of two package formulations the formulation containing imazethapyr and optionally imazamox and the formulation containing cycloxydim are mixed prior to application. In case the imazethapyr and optionally imazamox itself is a two package formulation the composition is in the form of a three-pack formulation. Preferably the mixing is performed as a tank mix, i.e. the formulations are mixed immediately prior or upon dilution with water.

The formulation may be in the form of a single package formulation containing imazethapyr, cycloxydim and bentazone and optionally imazamox together with liquid and/or solid carrier materials, and, if desired, one or more surfactants and, if desired, one or more further auxiliaries customary for crop protection compositions.

The formulation may be in form of a two package formulation or three package formulation, wherein one package may contain more than one herbicide and wherein each package may contain at least one carrier material, if desired, one or more surfactants and, if desired, one or more further auxiliaries customary for crop protection compositions. The formulation may be in form or a three package formulation or four package formulation, wherein each package may contain one herbicide and wherein each package may contain at least one carrier material, if desired, one or more surfactants and, if desired, one or more further auxiliaries customary for crop protection compositions. The different packages are mixed prior to application. Preferably the mixing is performed as a tank mix, i.e. the formulations are mixed immediately prior or upon dilution with water.

In the formulation of the present invention the active ingredients, i.e. imazethapyr, cycloxydim, optionally imazamox and optional further actives are present in suspended, emulsified or dissolved form. The formulation according to the invention can be in the form of aqueous solutions, powders, suspensions, also highly-concentrated aqueous, oily or other suspensions or dispersions, aqueous emulsions, aqueous microemulsions, aqueous suspoemulsions, oil dispersions, pastes, dusts, materials for spreading or granules.

Depending on the formulation type, they comprise one or more liquid or solid carriers, if appropriate surfactants (such as dispersants, protective colloids, emulsifiers, wetting agents and tackifiers), and if appropriate further auxiliaries which are customary for formulating crop protection products. The person skilled in the art is sufficiently familiar with the recipes for such formulations. Further auxiliaries include e.g. organic and inorganic thickeners, bactericides, antifreeze agents, antifoams, colorants and, for seed formulations, adhesives.

Suitable carriers include liquid and solid carriers. Liquid carriers include e.g. non-aqueous solvents such as cyclic and aromatic hydrocarbons, e.g. paraffins, tetrahydronaphthalene, alkylated naphthalenes and their derivatives, alkylated benzenes and their derivatives, alcohols such as methanol, ethanol, propanol, butanol and cyclohexanol, ketones such as cyclohexanone, strongly polar solvents, e.g. amines such as N-methylpyrrolidone, and water as well as mixtures thereof. Solid carriers include e.g. mineral earths such as silicas, silica gels, silicates, talc, kaolin, limestone, lime, chalk, bole, loess, clay, dolomite, diatomaceous earth, calcium sulfate, magnesium sulfate, magnesium oxide, ground synthetic materials, fertilizers such as ammonium sulfate, ammonium phosphate, ammonium nitrate, ureas, and products of vegetable origin such as cereal meal, tree bark meal, wood meal and nutshell meal, cellulose powders, or other solid carriers.

Suitable surfactants (adjuvants, wetting agents, tackifiers, dispersants and also emulsifiers) are the alkali metal salts, alkaline earth metal salts and ammonium salts of aromatic sulfonic acids, for example lignosulfonic acids (e.g. Borrespers™-types, Borregaard), phenolsulfonic acids, naphthalenesulfonic acids (Morwet types, Akzo Nobel) and dibutylnaphthalenesulfonic acid (Nekal® types, BASF SE), and of fatty acids, alkyl- and alkylarylsulfonates, alkyl sulfates, lauryl ether sulfates and fatty alcohol sulfates, and salts of sulfated hexa-, hepta- and octadecanols, and also of fatty alcohol glycol ethers, condensates of sulfonated naphthalene and its derivatives with formaldehyde, condensates of naphthalene or of the naphthalenesulfonic acids with phenol and formaldehyde, polyoxyethylene octylphenol ether, ethoxylated isooctyl-, octyl- or nonylphenol, alkylphenyl or tributylphenyl polyglycol ether, alkylaryl polyether alcohols, isotridecyl alcohol, fatty alcohol/ethylene oxide condensates, ethoxylated castor oil, polyoxyethylene alkyl ethers or polyoxypropylene alkyl ethers, lauryl alcohol polyglycol ether acetate, sorbitol esters, lignosulfite waste liquors and proteins, denaturated proteins, polysaccharides (e.g. methylcellulose), hydrophobically modified starches, polyvinyl alcohol (Mowiol® types Clariant), polycarboxylates (BASF SE, Sokalan® types), polyalkoxylates, polyvinylamine (BASF SE, Lupamine® types), polyethyleneimine (BASF SE, Lupasol® types), polyvinylpyrrolidone and copolymers thereof.

Examples of thickeners (i.e. compounds which impart to the formulation modified flow properties, i.e. high viscosity in the state of rest and low viscosity in motion) are polysaccharides, such as xanthan gum (Kelzan® from Kelco), Rhodopol® 23 (Rhone Poulenc) or Veegum® (from R.T. Vanderbilt), and also organic and inorganic sheet minerals, such as Attaclay® (from Engelhardt).

Examples of antifoams are silicone emulsions (such as, for example, Silikon®-SRE, Wacker or Rhodorsil® from Rhodia), long-chain alcohols, fatty acids, salts of fatty acids, organofluorine compounds and mixtures thereof.

Bactericides can be added for stabilizing the aqueous herbicidal formulations. Examples of bactericides are bactericides based on diclorophen and benzyl alcohol hemiformal (Proxel® from ICI or Acticide® RS from Thor Chemie and Kathon® MK from Rohm & Haas), and also isothiazolinone derivates, such as alkylisothiazolinones and benzisothiazolinones (Acticide® MBS from Thor Chemie).

Examples of antifreeze agents are ethylene glycol, propylene glycol, urea or glycerol.

Examples of colorants are both sparingly water-soluble pigments and water-soluble dyes.

Examples which may be mentioned are the dyes known under the names Rhodamin B, C.I. Pigment Red 112 and C.I. Solvent Red 1, and also pigment blue 15:4, pigment blue 15:3, pigment blue 15:2, pigment blue 15:1, pigment blue 80, pigment yellow 1, pigment yellow 13, pigment red 112, pigment red 48:2, pigment red 48:1, pigment red 57:1, pigment red 53:1, pigment orange 43, pigment orange 34, pigment orange 5, pigment green 36, pigment green 7, pigment white 6, pigment brown 25, basic violet 10, basic violet 49, acid red 51, acid red 52, acid red 14, acid blue 9, acid yellow 23, basic red 10, basic red 108.

Examples of adhesives are polyvinylpyrrolidone, polyvinyl acetate, polyvinyl alcohol and tylose.

To prepare emulsions, pastes or oil dispersions, the active the components, as such or dissolved in an oil or solvent, can be homogenized in water by means of wetting agent, tackifier, dispersant or emulsifier. Alternatively, it is possible to prepare concentrates consisting of active substance, wetting agent, tackifier, dispersant or emulsifier and, if desired, solvent or oil, and these concentrates are suitable for dilution with water.

Powders, materials for spreading and dusts can be prepared by mixing or concomitant grinding of the active the components imazethapyr and cycloxydim and optionally imazamox and optionally safener with a solid carrier.

Granules, e.g. coated granules, impregnated granules and homogeneous granules, can be prepared by binding the active ingredients to solid carriers.

The formulations of the invention comprise a herbicidally effective amount of the composition of the present invention. The concentrations of the active ingredients in the formulations can be varied within wide ranges. In general, the formulations comprise from 1 to 98% by weight, preferably 10 to 60% by weight, of active ingredients (sum of imazethapyr and cycloxydim and optionally imazamox and/or further acitves; sum of imazethapyr, cycloxydim and bentazone and optionally imazamox and/or further actives). The active ingredients are employed in a purity of from 90% to 100%, preferably 95% to 100% (according to NMR spectrum).

The active compounds imazethapyr and cycloxydim and optionally imazamox as well as the compositions according to the invention can, for example, be formulated as follows: 1. Products for Dilution with Water

A Water-Soluble Concentrates

10 parts by weight of active compound (or composition) are dissolved in 90 parts by weight of water or a water-soluble solvent. As an alternative, wetters or other adjuvants are added. The active compound dissolves upon dilution with water. This gives a formulation with an active compound content of 10% by weight.

B Dispersible Concentrates

20 parts by weight of active compound (or composition) are dissolved in 70 parts by weight of cyclohexanone with addition of 10 parts by weight of a dispersant, for example polyvinylpyrrolidone. Dilution with water gives a dispersion. The active compound content is 20% by weight.

C Emulsifiable Concentrates

15 parts by weight of active compound (or composition) are dissolved in 75 parts by weight of an organic solvent (eg. alkylaromatics) with addition of calcium dodecyl-benzenesulfonate and castor oil ethoxylate (in each case 5 parts by weight). Dilution with water gives an emulsion. The formulation has an active compound content of 15% by weight.

D Emulsions

25 parts by weight of active compound (or composition) are dissolved in 35 parts by weight of an organic solvent (eg. alkylaromatics) with addition of calcium dodecyl-benzenesulfonate and castor oil ethoxylate (in each case 5 parts by weight). This mixture is introduced into 30 parts by weight of water by means of an emulsifier (Ultraturrax) and made into a homogeneous emulsion. Dilution with water gives an emulsion. The formulation has an active compound content of 25% by weight.

E Suspensions

In an agitated ball mill, 20 parts by weight of active compound (or composition) are comminuted with addition of 10 parts by weight of dispersants and wetters and 70 parts by weight of water or an organic solvent to give a fine active compound suspension. Dilution with water gives a stable suspension of the active compound. The active compound content in the formulation is 20% by weight.

F Water-Dispersible Granules and Water-Soluble Granules

50 parts by weight of active compound (or composition) are ground finely with addition of 50 parts by weight of dispersants and wetters and made into water-dispersible or water-soluble granules by means of technical appliances (for example extrusion, spray tower, fluidized bed). Dilution with water gives a stable dispersion or solution of the active compound. The formulation has an active compound content of 50% by weight.

G Water-Dispersible Powders and Water-Soluble Powders

75 parts by weight of active compound (or composition) are ground in a rotor-stator mill with addition of 25 parts by weight of dispersants, wetters and silica gel. Dilution with water gives a stable dispersion or solution of the active compound. The active compound content of the formulation is 75% by weight.

H Gel Formulations

In a ball mill, 20 parts by weight of active compound (or composition), 10 parts by weight of dispersant, 1 part by weight of gelling agent and 70 parts by weight of water or of an organic solvent are mixed to give a fine suspension. Dilution with water gives a stable suspension with active compound content of 20% by weight.

2. Products to be Applied Undiluted

I Dusts

5 parts by weight of active compound (or composition) are ground finely and mixed intimately with 95 parts by weight of finely divided kaolin. This gives a dusting powder with an active compound content of 5% by weight.

J Granules (GR, FG, GG, MG)

0.5 parts by weight of active compound (or composition) are ground finely and associated with 99.5 parts by weight of carriers. Current methods here are extrusion, spray-drying or the fluidized bed. This gives granules to be applied undiluted with an active compound content of 0.5% by weight.

K ULV Solutions (UL)

10 parts by weight of active compound (or composition) are dissolved in 90 parts by weight of an organic solvent, for example xylene. This gives a product to be applied undiluted with an active compound content of 10% by weight.

Aqueous use forms can be prepared from emulsion concentrates, suspensions, pastes, wettable powders or water-dispersible granules by adding water.

It may furthermore be beneficial to apply the compositions of the invention alone or in combination with other herbicides, or else in the form of a mixture with other crop protection agents, for example together with agents for controlling pests or phytopathogenic fungi or bacteria. Also of interest is the miscibility with mineral salt solutions, which are employed for treating nutritional and trace element deficiencies. Other additives such as non-phytotoxic oils and oil concentrates may also be added.

Synergism can be described as an interaction where the combined effect of two or more compounds is greater than the sum of the individual effects of each of the compounds. The presence of a synergistic effect in terms of percent control, between two mixing partners (X and Y) can be calculated using the Colby equation (Colby, S. R., 1967, Calculating Synergistic and Antagonistic Responses in Herbicide Combinations, Weeds, 15, 21-22):

$$E = X + Y - \frac{XY}{100}$$

When the observed combined control effect is greater than the expected (calculated) combined control effect (E), then the combined effect is synergistic.

The following tests demonstrate the control efficacy of compounds, mixtures or compositions of this invention on specific weeds. However, the weed control afforded by the compounds, mixtures or compositions is not limited to these species. The analysis of synergism or antagonism between the mixtures or compositions was determined using Colby's equation. Analogously, the Colby's equation can be used to determine synergism of 3-way and higher mixtures.

### EXAMPLES

Products:

Imazethapyr—70% WG

Imazamox—70% WG

(Imazethapyr 35+Imazamox 35)—70% WG—Ready mix

Cycloxydim—200 g/lit EC

Weeds in the Study

| EPPO | |
|---|---|
| Code | Scientific Name |
| ECHCO | Echinochloa |
| | colonum |
| LEFFA | Leptochloa fusca |
| ORYSA | Orysa sativa |
| PHACA | Phalaris |
| | canariensis |
| BRADE | Brachiaria deflexa |
| BRAPL | Brachiaria |
| | plantaginea |

### Example 1

### Post Emergence Treatment by the Mixture of Imazethapyr+Cycloxydim

| | | Herbicidal activity against | | | | | |
|---|---|---|---|---|---|---|---|
| Application rate in g ai/ha | | ECHCO | | LEFFA | | ORYSA | |
| Imazethapyr | Cycloxydim | Found | Calculated | Found | Calculated | Found | Calculated |
| 7.5 | — | 85 | — | 55 | — | 50 | — |
| — | 6 | 50 | — | 40 | — | 20 | — |
| 7.5 | 6 | 95 | 93 | 85 | 73 | 80 | 60 |

### Example 2

### Post Emergence Treatment by the Mixture of (Imazethapyr+Imazamox)+Cycloxydim

| Application rate in g ai/ha | | Herbicidal activity against | | | |
|---|---|---|---|---|---|
| (Imazethapyr + | | PHACA | | ECHCO | |
| Imazamox) | Cycloxydim | Found | Calculated | Found | Calculated |
| 30 | — | 50 | — | 98 | — |
| — | 3 | 0 | — | 0 | — |
| 30 | 3 | 85 | 50 | 100 | 98 |

| Application rate in g ai/ha | | Herbicidal activity against | | | |
|---|---|---|---|---|---|
| (Imazethapyr + | | PHACA | | ORYSA | |
| Imazamox) | Cycloxydim | Found | Calculated | Found | Calculated |
| 15 | — | 85 | — | 90 | — |
| — | 6 | 60 | — | 20 | — |
| 15 | 6 | 95 | 94 | 95 | 92 |

| Application rate in g ai/ha | | Herbicidal activity against | | | |
|---|---|---|---|---|---|
| (Imazethapyr + | | PHACA | | BRAPL | |
| Imazamox) | Cycloxydim | Found | Calculated | Found | Calculated |
| 15 | — | 50 | — | 80 | — |
| — | 3 | 0 | — | 0 | — |
| 15 | 3 | 75 | 50 | 85 | 80 |

The invention further refers to the following embodiments:

1. Herbicidal compositions comprising imazethapyr, or an agriculturally acceptable salt thereof and cycloxydim, or an agriculturally acceptable salt thereof and optionally imazamox, or an agriculturally acceptable salt thereof.

2. Compositions according to embodiment 1, additionally containing a safener.

3. Compositions according to embodiment 1, containing no safener.

4. Compositions as according to any of the preceding embodiments, wherein the relative amount of imazethapyr to (optionally) imazamox and cycloxydim is in synergistically effective amounts.

5. Compositions as according to any of the preceding embodiments, wherein the relative amount of imazethapyr to cycloxydim is from 100:1 to 1:100, preferably 10:1 to 1:10.

6. The use of the compositions according to any of the preceding embodiments for controlling undesirable vegetation.

7. The use according to embodiment 6 for controlling undesirable vegetation in crop plants.

8. The use according to embodiment 7, wherein the crop plants are leguminous crops.

9. The use according to embodiment 8, wherein the crop plants are leguminous crops selected from soybean, green gram, black gram, peas, cluster beans, pulse crops, peanut.

10. The use according to embodiment 9, wherein the crop plant is soybean.

11. The use according to embodiment 7, wherein the crop plants are tolerant to acetohydroxyacid synthase inhibiting herbicides.

12. The use according to embodiment 11, wherein the crop plants tolerant to acetohydroxyacid synthase inhibiting herbicides are wheat, barley, canola, corn, lentils, oilseed rape, rice, soybean or sunflower.

13. A method for controlling undesirable vegetation, which comprises allowing a composition as according to embodiments 1 to 5 to act on plants to be controlled or their habitat.

14. A method for controlling undesired vegetation according to embodiment 13, which comprises applying the composition according to embodiments 1 to 5 before, during and/or after the emergence of the undesirable plants; the herbicides imazethapyr and cycloxydim and optionally imazamox being applied simultaneously or in succession.

15. An herbicide formulation comprising a composition according to embodiments 1 to 5 and at least one solid or liquid carrier.

1.-15. (canceled)

16. Herbicidal compositions comprising imazethapyr, or an agriculturally acceptable salt thereof and cycloxydim, or an agriculturally acceptable salt thereof and optionally imazamox, or an agriculturally acceptable salt thereof.

17. Composition according to claim 16, wherein the composition additionally comprises bentazone.

18. Compositions as claimed in claim 16, wherein the relative amount of imazethapyr to imazamox and cycloxydim is in synergistically effective amounts.

19. Compositions as claimed in claim 16, wherein the relative amount of imazethapyr to cycloxydim is from 100:1 to 1:100.

20. A method for controlling undesired vegetation, which comprises allowing a composition as claimed in claim 16 to act on the undesired vegetation to be controlled or their habitat.

21. The method of claim 20, wherein the undesired vegetation is monocotyledonous weeds.

22. The method of claim 21, wherein the monocotyledonous weeds are selected from the group consisting of Dinebra spec., Echinochloa spec., Leptochloa spec., Phalaris spec., Brachiaria spec.

23. The method of claim 21, wherein the monocotyledonous weeds are selected from the group consisting of Dinebra arabica, Echinochloa colonum, Leptochloa fusca, Phalaris canariensis, Brachiaria deflexa, Brachiaria plantaginea.

24. The method of claim 20, undesired vegetation is in crop plants.

25. The method of claim 24, wherein the crop plants are leguminous crops selected from soybean, green gram, black gram, peas, cluster beans, pulse crops, peanut, preferably soybean.

26. The method of claim 24, wherein the crop plants are tolerant to acetohydroxyacid synthase inhibiting herbicides, and wherein preferably the crop plants tolerant to acetohydroxyacid synthase inhibiting herbicides are wheat, barley, canola, corn, lentils, oilseed rape, rice, soybean or sunflower.

27. A method for controlling undesired vegetation which comprises applying, before, during and/or after the emergence of the undesired vegetation, imazethapyr and cycloxydim and optionally imazamox being applied simultaneously or in succession.

28. A method for controlling undesired vegetation which comprises applying, before, during and/or after the emergence of the undesired vegetation, imazethapyr, cycloxydim and bentazone and optionally imazamox being applied simultaneously or in succession.

29. An herbicide formulation comprising a composition as claimed in claim 16 and at least one solid or liquid carrier.

30. The method of claim 27, wherein the undesired vegetation is monocotyledonous weeds.

31. The method of claim 30, wherein the monocotyledonous weeds are selected from the group consisting of Dinebra spec., Echinochloa spec., Leptochloa spec., Phalaris spec., Brachiaria spec.

32. The method of claim 30, wherein the monocotyledonous weeds are selected from the group consisting of Dinebra arabica, Echinochloa colonum, Leptochloa fusca, Phalaris canariensis, Brachiaria deflexa, Brachiaria plantaginea.

33. The method of claim 20, undesired vegetation is in crop plants.

34. The method of claim 33, wherein the crop plants are leguminous crops selected from soybean, green gram, black gram, peas, cluster beans, pulse crops, peanut, preferably soybean.

35. The method of claim 33, wherein the crop plants are tolerant to acetohydroxyacid synthase inhibiting herbicides, and wherein preferably the crop plants tolerant to acetohydroxyacid synthase inhibiting herbicides are wheat, barley, canola, corn, lentils, oilseed rape, rice, soybean or sunflower.
